(19) United States
(12) Patent Application Publication
(10) Pub. No.: US 2018/0161803 A1
(43) Pub. Date: Jun. 14, 2018

(54) METHOD AND APPARATUS FOR PRODUCING FUNCTIONAL FILM

(71) Applicant: FUJIFILM Corporation, Tokyo (JP)

(72) Inventor: Satoshi Kuniyasu, Kanagawa (JP)

(73) Assignee: FUJIFILM Corporation, Tokyo (JP)

(21) Appl. No.: 15/890,897

(22) Filed: Feb. 7, 2018

Related U.S. Application Data
(63) Continuation of application No. PCT/JP2016/070299, filed on Jul. 8, 2016.

(30) Foreign Application Priority Data
Aug. 11, 2015 (JP) 2015-158628

(51) Int. Cl. B05C 9/08; B05D 1/26; B05D 3/04; B05D 3/12; B05C 5/02

(52) U.S. Cl. CPC B05C 9/08; B05D 1/26; B05C 5/02; B05D 3/12; B05D 3/0493

(57) ABSTRACT

Provided are a method and an apparatus for producing a functional film with a coating solution including a material whose performance is deteriorated by oxygen, without performance deterioration. The method for producing a functional film includes a coating step of supplying a coating solution having a dissolved oxygen concentration of 1000 ppm or less to a die coater having a backup roller and applying the coating solution to a flexible support transported in a state where the support is wound around the backup roller by the die coater, in which a reduced pressure chamber which covers a surface of the flexible support is provided on an upstream side of the die coater in a transport direction of the flexible support, and an inert gas is supplied to the reduced pressure chamber and an exhaust amount from the reduced pressure chamber is larger than a supply amount of the inert gas.

### CROSS-REFERENCE TO RELATED APPLICATIONS

This application is a Continuation of PCT International Application No. PCT/JP2016/070299 filed on Jul. 8, 2016, which claims priority under 35 U.S.C. § 119(a) to Japanese Patent Application No. 2015-158628 filed on Aug. 11, 2015. Each of the above applications is hereby expressly incorporated by reference, in their entirety, into the present application.

### BACKGROUND OF THE INVENTION

### 1. Field of the Invention

The present invention relates to a method and an apparatus for producing a functional film and particularly relates to a method and an apparatus for producing a functional film using a coating solution that includes a material whose performance is deteriorated by oxygen.

### 2. Description of the Related Art

A functional film having an optical function is produced by forming a coated film by applying a coating solution including a material having functionality such as optical properties or the like to a flexible support.

However, among materials having functionality, there is a material whose performance is deteriorated by oxygen, and this material causes a problem in the production of a functional film. As a material whose performance is deteriorated by oxygen, for example, there is a quantum dot (also referred to as QD or a quantum point) used as a light emitting material for a flat panel display such as a liquid crystal display (LCD) (hereinafter, also referred to as LCD).

In the flat panel display market, improvement in color reproducibility has progressed as improvement of LCD performance. Regarding this point, in recent years, a quantum dot has attracted attention as a light emission material. For example, in a case where exciting light is incident on a wavelength conversion member including a quantum dot from a backlight, the quantum dot is excited and emits fluorescent light. Here, in a case of using quantum dots having different light emission properties, white light can be realized by emitting light having a narrow half-width of red light, green light, and blue light. Since the fluorescent light by the quantum dots has a narrow half-width, wavelengths can be properly selected to thereby allow the white light to be designed so that the white light is high in brightness and excellent in color reproducibility.

Due to the progress of such a three-wavelength light source technique using quantum dots, the color reproduction range has been widened from 72% to 100% in terms of current television (TV) standards (Full High Definition (FHD)) and National Television System Committee (NTSC) ratio.

However, the quantum yield of the quantum dot is deteriorated by oxygen and water vapor and thus as a countermeasure against this problem, a film having gas barrier properties is laminated on a coating that is formed on a flexible support by coating (quantum dot-containing layer) to protect the film from oxygen and water vapor.

JP2013-544018A discloses a laminated film formed by laminating a quantum dot-containing layer and gas barrier films having high oxygen barrier properties and water vapor barrier properties in such a manner that both surfaces of the quantum dot-containing layer are interposed between the gas barrier films in order to protect a quantum dot from oxygen and water vapor. In addition, JP2003-181350A discloses that oxygen concentration at coating is reduced by filling a coating bead upstream side with a gas having, as a main component, an inert gas in which the oxygen concentration is 0.5% to 8%, the relative humidity of an organic solvent is 80% to 100%, and the amount of moisture is 0.5 to 5 Vol %.

### SUMMARY OF THE INVENTION

However, even in a film formed by laminating a quantum dot-containing layer and gas barrier films having high oxygen barrier properties and water vapor barrier properties such that both surfaces of the quantum dot-containing layer are interposed between the gas barrier films, there are problems of insufficient protection against oxygen and performance deterioration of a produced functional film due to oxygen. In addition, in the apparatus disclosed in JP2003-181350A, in order to reduce generation of coating failure, an inert gas is supplied and in a case where a coating solution includes a component which is deteriorated by oxygen, the concentration described in JP2003-181350A is not sufficient.

This problem is not limited to the quantum dot and also arises in the production of a functional film using a coating solution including a material whose performance is deteriorated by oxygen.

The present invention is made in consideration of the above circumstances, and an object thereof is to provide a method and an apparatus for producing a functional film capable of producing a functional film without performance deterioration in a case where the film is produced with a coating solution that includes a material whose performance is deteriorated by oxygen.

In order to achieve the object, according to an aspect of the present invention, there is provided a method for producing a functional film comprising: method for producing a functional film comprising: a coating step of supplying a coating solution having a dissolved oxygen concentration of 1000 ppm or less to a die coater having a backup roller and applying the coating solution to a flexible support which is transported in a state in which the support is wound around the backup roller by the die coater, in which a reduced pressure chamber which covers a surface of the flexible support is provided on an upstream side of the die coater in a transport direction of the flexible support, and an inert gas is supplied to the reduced pressure chamber and an exhaust amount from the reduced pressure chamber is larger than a supply amount of the inert gas to the reduced pressure chamber.

According to the aspect of the present invention, in the coating step, a coating solution having a dissolved oxygen concentration of 1000 ppm or less is supplied to a die coater having a backup roller and applied to a flexible support which is transported in a state in which the support is wound around the backup roller. Accordingly, since the dissolved oxygen concentration in the coating solution can be reduced, even in a case where a material whose performance is deteriorated by oxygen is included in the coating solution, it is possible to suppress performance deterioration of a functional film to be produced.

In addition, by performing coating by a die coater, compared to other coating devices, it is possible to effectively reduce a chance of contact between the coating solution and external air (oxygen in external air). Further, since a reduced pressure chamber is provided on an upstream side of the die coater and an exhaust amount from the reduced pressure chamber is set to be larger than a supply amount of the inert gas, it is possible to reduce the pressure in the reduced pressure chamber. A bead can be formed between the die coater and the flexible support by reducing the pressure in the reduced pressure chamber and the vicinity of the bead can be put under an inert gas atmosphere by using an inert gas as a gas to be supplied into the reduced pressure chamber. Thus, it is possible to suppress contact between the coating solution and oxygen in the coating step.

In the aspect of the present invention, it is preferable that a concentration of an organic solvent in the coating solution is 10000 ppm or less.

According to the aspect, by setting a concentration of an organic solvent in the coating solution to 10000 ppm or less, a state in which a solvent gas does not flow down from the bead can be created in the reduced pressure chamber and a gas flow in the reduced pressure chamber can be stabilized. By stabilizing the gas flow, the variation width of the oxygen concentration in the reduced pressure chamber can be reduced and thus it is possible to suppress performance deterioration of a functional film to be produced.

In the aspect of the present invention, it is preferable that a pressure reduction degree in the reduced pressure chamber is 10 Pa or more.

In the aspect, the pressure reduction degree in the reduced pressure chamber is defined and by setting the pressure reduction degree to 10 Pa or more, the gas flow in the reduced pressure chamber can be stabilized, and the variation width of the oxygen concentration in the reduced pressure chamber can be reduced. Thus, it is possible to suppress performance deterioration of a functional film to be produced.

In the aspect of the present invention, it is preferable that an oxygen concentration of the inert gas is adjusted to less than 5000 ppm.

According to the aspect, by using an inert gas of which the oxygen concentration is adjusted, the oxygen concentration in the reduced pressure chamber can be set to the oxygen concentration of the inert gas, and the oxygen concentration in the reduced pressure chamber can be stabilized. Thus, it is possible to suppress performance deterioration of a functional film to be produced.

In the aspect of the present invention, it is preferable that a supply amount of the inert gas is 100 L/min/m or more and 10000 L/min/m or less.

In the aspect, the supply amount of the inert gas is defined and the inside of the reduced pressure chamber can put under an inert gas atmosphere by setting the supply amount of the inert gas to be in the above range. A case where the supply amount of the inert gas is out of the above range is not preferable since air easily enters the reduced pressure chamber or the oxygen concentration is not stabilized.

In order to achieve the object, according to another aspect of the present invention, there is provided an apparatus for producing a functional film comprising: coating means having a backup roller and a die coater for applying a coating solution having a dissolved oxygen concentration of 1000 ppm or less to a flexible support which is transported in a state in which the support is wound around the backup roller; a reduced pressure chamber which covers a surface of the flexible support and is provided on an upstream side in a transport direction of the flexible support; inert gas supply means for supplying an inert gas into the reduced pressure chamber; and exhaust means for exhausting a gas in the reduced pressure chamber, in which an exhaust amount of the exhaust means is larger than a supply amount of the inert gas supply means.

The present invention is an apparatus for producing a functional film having a configuration capable of implementing the above-described method for producing a functional film, and even in a case where the coating solution includes a material whose performance is deteriorated by oxygen, performance deterioration of a functional film to be produced can be suppressed by suppressing contact between the coating solution and oxygen.

In the aspect of the present invention, it is preferable that a concentration of an organic solvent in the coating solution is 10000 ppm or less.

According to the aspect, by setting a concentration of an organic solvent in the coating solution to 10000 ppm or less, a state in which a solvent gas does not flow down from the bead can be created in the reduced pressure chamber and a gas flow in the reduced pressure chamber can be stabilized. By stabilizing the gas flow, the variation width of the oxygen concentration in the reduced pressure chamber can be reduced and thus it is possible to suppress performance deterioration of a functional film to be produced.

In the aspect of the present invention, it is preferable that the inert gas supply means is a die block which is arranged on an upstream side of the die coater in the transport direction of the flexible support and has a slit for supplying the inert gas.

According to the aspect, by using a die block having a slit which is arranged on an upstream side of the die coater as the inert gas supply means and supplying the inert gas from the slit, the upstream side of the coating position can be put under an inert gas atmosphere and contact between the coating solution and external air can be suppressed.

In the aspect of the present invention, it is preferable that a pressure reduction degree in the reduced pressure chamber is 10 Pa or more.

In the aspect of the present invention, it is preferable that an oxygen concentration of the inert gas is adjusted to less than 5000 ppm.

In the aspect of the present invention, it is preferable that a supply amount of the inert gas is 100 L/min/m or more and 10000 L/min/m or less.

These aspects are apparatus configurations for the method for producing a functional film and have the same effect as that of the above-described method of producing a functional film.

According to the method and the apparatus for producing a functional film, by providing a reduced pressure chamber on the upstream side of the die coater and putting the inside of the reduced pressure chamber under an inert gas atmosphere, contact between the coating solution and oxygen can be suppressed at application of the coating solution. Accordingly, it is possible to suppress performance deterioration of a functional film to be produced.

### BRIEF DESCRIPTION OF THE DRAWINGS

FIG. 1 is a view showing the overall configuration of an apparatus for producing a functional film.

FIG. 2 is a view showing a main part of an apparatus for producing a functional film using die block type inert gas supply means.

FIG. 3 is an enlarged view of a coating part.

FIG. 4 is a view showing a main part of an apparatus for producing a functional film using another embodiment of inert gas supply means.

### DESCRIPTION OF THE PREFERRED EMBODIMENTS

Hereinafter, a method and an apparatus for producing a functional film according to the present invention will be described in detail with reference to accompanying drawings. The present invention is a technique of producing a functional film with a coating solution including a material whose performance is deteriorated by oxygen, and an example in which a functional film having an optical functional layer as a wavelength conversion member is produced with a coating solution including a quantum dot as a material whose performance is deteriorated by oxygen will be described. However, the present invention is not limited to the quantum dot and can be applied to all methods for production of a functional film using a coating solution including a material whose performance is deteriorated by oxygen. In the specification, any numerical range expressed herein using “to” refers to a range including the numerical values before and after the “to”, as the upper limit and the lower limit, respectively.

<Apparatus for Producing Functional Film>

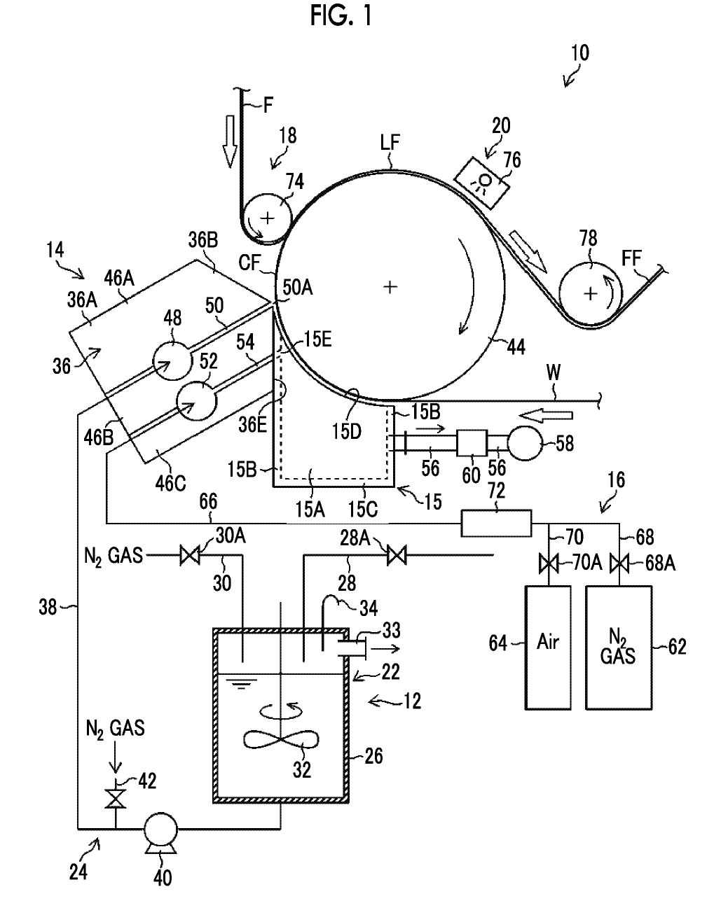

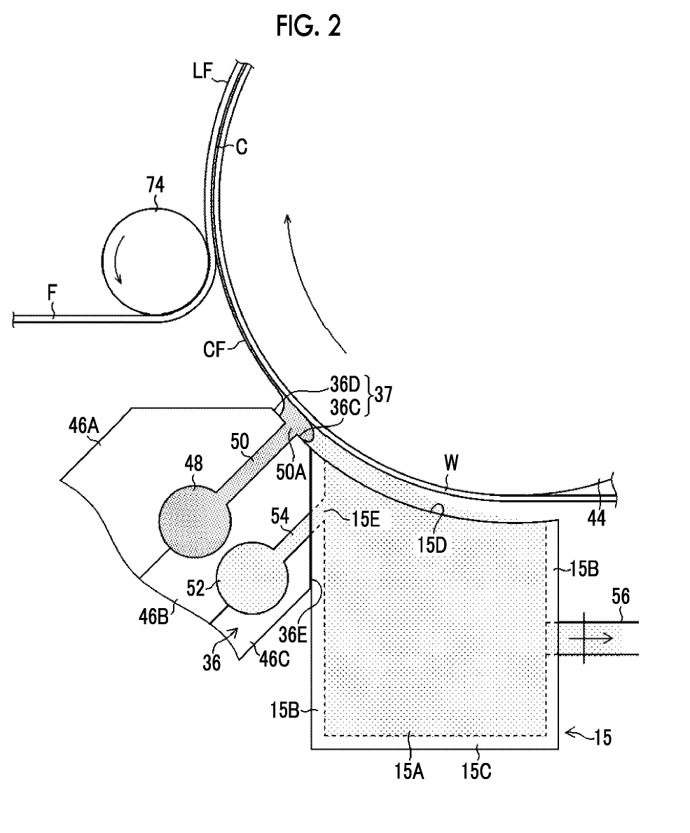

FIG. 1 is a view showing the overall configuration of an apparatus for producing a functional film and FIG. 2 is a view showing a main part of an apparatus for producing a functional film using die block type inert gas supply means. An apparatus 10 for producing a functional film mainly includes a dissolved oxygen reducing device 12 which reduces a dissolved oxygen concentration in a functional layer forming coating solution containing a quantum dot (hereinafter, referred to as “coating solution”) to 1000 ppm or less, a coating device 14 (corresponding to coating means) which applies the coating solution, a reduced pressure chamber 15 which is provided on an upstream side of the coating device 14 in a transport direction of a flexible support W and covers a surface of a belt-like flexible support, an inert gas supply device 16 (corresponding to inert gas supply means) which supplies an inert gas into the reduced pressure chamber 15, a lamination device 18 which laminates a film F on a coating C formed by coating, and a curing device 20 which cures the coating. In the embodiment, nitrogen gas (N₂ gas) will be described as an example of an inert gas below. In addition, the details of the composition contents of the coating solution containing a quantum dot will be described in the section of a method for producing a functional film.

In addition, in the following description, a film that is obtained by applying the coating solution to a flexible support W is referred to as a coated film CF, a film that is obtained by laminating a film F on the coated film CF is referred to as a laminated film LF, and a film having an optical functional layer that is obtained by performing a curing treatment on a coating C of the laminated film LF is referred to as a functional film FF.

(Dissolved Oxygen Reducing Device)

The dissolved oxygen reducing device 12 may adopt any configuration as long as the device can reduce the dissolved oxygen concentration in the coating solution to 1000 ppm or less. For example, the device configuration as shown in FIG. 1 can be adopted.

As shown in FIG. 1, the dissolved oxygen reducing device 12 mainly includes nitrogen gas substituting means 22 and coating solution supply means 24 for supplying the coating solution having reduced dissolved oxygen to the coating device 14.

The nitrogen gas substituting means 22 includes a sealed tank 26 which stores the coating solution, a coating solution pipe 28 which supplies the coating solution into the tank 26, a nitrogen gas pipe 30 which supplies nitrogen gas into the tank 26, a stirrer 32 which causes the nitrogen gas to be incorporated in the coating solution by stirring the coating solution so as to reduce the amount of dissolved oxygen in the coating solution, and a pressure reducing pipe 33 which volatilizes an organic solvent in the tank 26 by reducing the pressure in the tank 26. An air vent pipe 34 is provided in the tank 26 and opening and closing valves 28A and 30A are respectively provided in the coating solution pipe 28 and the nitrogen gas pipe 30. In addition, the pressure reducing pipe 33 is connected to a vacuum device (not shown), the pressure in the tank 26 is reduced by operating the vacuum device, dissolved oxygen in the coating solution is degassed, and in a case where the coating solution contains an organic solvent, the organic solvent is evaporated.

The coating solution supply means 24 includes a liquid feeding pipe 38 and a liquid feeding pump 40 for feeding the coating solution in the tank 26 to a die coater 36 of the coating device 14, and a nitrogen gas blowing pipe 42 for blowing nitrogen gas into the liquid feeding pipe 38 and substituting the air in the liquid feeding pipe 38 and the side (manifold, slit) of the die coater 36 by the nitrogen gas.

Although not shown in FIG. 1, a configuration in which a plurality of nitrogen gas substituting means 22 are arranged in parallel so that the nitrogen gas substituting means 22 can be used by switching between the nitrogen gas substituting means 22 and the coating solution supply means 24 is adopted and thus continuous coating can be performed.

(Coating Device)

As shown in FIG. 1, the coating device 14 mainly includes a backup roller 44 and the die coater 36.

The die coater 36 is formed by die blocks 46A, 46B, and 46C and is formed in a block shape long in a coating width direction in which the cross section of a body portion 36A orthogonal to the coating width direction is formed in a rectangular shape and a cross section of a distal end lip portion 36B is formed in a triangular shape. By combining the die blocks 46A and 46B, a manifold 48 which expands a flow of the coating solution supplied to the die coater 36 in a coating width direction and a narrow slit 50 (also referred to as a slot) which discharges the flow-expanded coating solution from a discharging port 50A of the distal end lip portion 36B are formed in the die coater 36. In addition, by combining the die blocks 46B and 46C, a manifold 52 and a slit 54 for discharging nitrogen gas in the coating width direction are formed.

On the distal end surface of the distal end lip portion 36B in which a discharging port 50A of the slit 50 is formed, a flat portion called a land 37 is formed, and as seen from a transport direction of the flexible support W which is transported in a state in which the support is wound around the backup roller 44, a land on an upstream side of the slit is referred to as an upstream side lip land 36C and a land on a downstream side thereof is referred to as a downstream side lip land 36D (refer to FIG. 2).

(Reduced Pressure Chamber)

The reduced pressure chamber 15 is arranged opposite to the backup roller 44 on the lower side of the distal end lip portion 36B of the die coater 36 (on the upstream side of the die coater as seen from the transport direction of the flexible support W).

The reduced pressure chamber 15 is formed in a box having an opening 15D formed along the roller surface of the backup roller 44 by a pair of side plates 15A and 15A, a pair of back plates 15B and 15B, and a bottom plate 15C. Between an upper end of the side plate 15A and the flexible support W which is transported in a state in which the support is wound around the backup roller 44, and between an upper end of the back plate 15B and the flexible support W, gaps to a degree of avoiding contact with each other are formed. In addition, the side of the back plate 15B of the reduced pressure chamber 15 close to the die coater 36 is made to abut on an upstream side inclined surface 36E of the distal end lip portion 36B of the die coater 36 that is formed in a triangular shape and an opening portion 15E is provided at the position of the slit 54 for discharging nitrogen gas.

The inside of the reduced pressure chamber 15 is connected to a blower 58 (corresponding to exhaust means) through a pipe 56 and air in the reduced pressure chamber 15 is continuously sucked to reduce the pressure. The pipe 56 is preferably positioned at the center of the surface of the back plate 15B opposite to the die coater 36 or at the center of the surface of the bottom plate 15C. The effect of pressure variation may be reduced by providing a buffer 60 between the reduced pressure chamber 15 and the blower 58. In addition, a valve which adjusts a pressure reduction degree may be provided between the reduced pressure chamber 15 and the blower 58 or a pressure reduction degree may be adjusted by controlling the number of rotations of the blower.

(Inert Gas Supply Device)

The inert gas supply device 16 is a device which supplies nitrogen gas (inert gas) to the manifold 52 formed in the die coater 36. As nitrogen gas, nitrogen gas of which the oxygen concentration is not adjusted may be supplied but nitrogen gas of which the oxygen concentration is adjusted is preferably supplied.

For adjustment of oxygen concentration in nitrogen gas any apparatus configuration may be adopted as long as the oxygen concentration in nitrogen gas can be reduced to a predetermined concentration or less and for example, an apparatus configuration shown in FIG. 1 can be used. The inert gas supply device 16 includes a nitrogen cylinder 62 which is filled with nitrogen gas, an air cylinder 64 which is filled with air, and a common supply pipe 66 which supplies mixed nitrogen gas and air to the manifold 52 of the die coater 36. The nitrogen cylinder 62 and the common supply pipe 66 are connected to each other through a nitrogen gas supply pipe 68 and are provided with an opening and closing valve 68A which adjusts a flow rate of nitrogen gas. In addition, the air cylinder 64 and the common supply pipe 66 are connected to each other through an air supply pipe 70 and are provided with an opening and closing valve 70A which adjusts a flow rate of air. In the common supply pipe 66, measurement means 72 for measuring oxygen concentration of nitrogen gas of which the oxygen concentration is adjusted is provided and the oxygen concentration can be adjusted by controlling the opening and closing valves 68A and 70A based on the concentration value of the measurement means 72.

By supplying the inert gas into the reduced pressure chamber 15 by the inert gas supply device 16 and operating the blower 58, in a state in which the pressure in the reduced pressure chamber 15 is reduced, the inside of the reduced pressure chamber can be put under an inert gas atmosphere. Thus, the coating solution discharged from the slit 50 of the die coater 36 forms a coating solution bead between the land 37 and the flexible support W which is transported in a state in which the support is wound around the backup roller 44 and the coating solution is applied to the flexible support W through the bead. In addition, the bead is stably formed by providing the reduced pressure chamber 15 and the coating solution is applied to the flexible support W with high accuracy. Thus, a coated film CF on which the coating C of the coating solution containing a quantum dot is formed is formed.

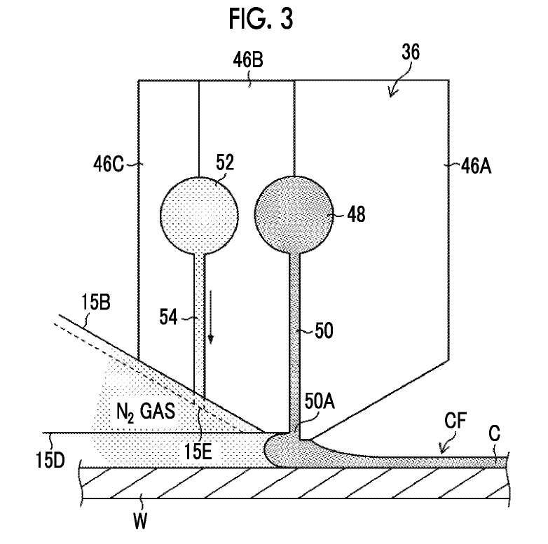

FIG. 3 is an enlarged view of a coated part of the coating device. As shown in FIG. 3, the coating solution discharged from the slit 50 of the die coater 36 is applied to the flexible support W through the coating solution bead and a nitrogen gas atmosphere can be formed around the bead. Thus, it is possible to suppress contact with oxygen.

In this manner, a low dissolved oxygen concentration coating solution having a dissolved oxygen concentration of 1000 ppm or less is supplied to the extrusion coating type die coater 36 including the manifold 48 and the slit 50 and is applied to the flexible support W which is transported in a state in which the support is wound around the backup roller 44 through the bead, and the upstream side of the slit 50 can be put under an inert gas atmosphere. Thus, a chance of contact between the coating solution and external air (oxygen in external air) can be reduced.

(Lamination Device)

As shown in FIG. 1, the lamination device 18 is a device which laminates a film F on the coated surface of the coated film CF on the backup roller 44. The lamination device 18 includes the backup roller 44 that is also used in the coating device 14, and a lamination roller 74 arranged opposite to the backup roller 44 on the downstream side of the coating device 14 as seen from a rotation direction of the backup roller 44. Thus, the lamination roller 74 and the backup roller 44 constitute a nip roller. The lamination roller 74 is preferably positioned at a position close to the die coater 36 since contact between the coating C and oxygen in the air is suppressed.

The film F fed from a feeding machine (not shown) is wound around the lamination roller 74 and continuously transported between the lamination roller 74 and the backup roller 44, and nip operation is performed by the lamination roller 74 and the backup roller 44. Then, the film F is laminated on the coated surface of the coated film CF. Thus, a laminated film LF in which the coating C is sandwiched between the flexible support W and the film F is formed and the coating C is protected from a deterioration factor such as oxygen.

Regarding the nip pressure by the lamination roller 74 and the backup roller 44, the film F is laminated on the coating C by preferably performing nipping at a line pressure of 0 to 300 N/cm, more preferably performing nipping at a line pressure of 0 to 200 N/cm, and particularly preferably performing nipping at a line pressure of 0 to 100 N/cm. In the above range, it is preferable that the lamination roller 74 is used as an approach roller approaching the backup roller 44 and the film is laminated on the coating at a line pressure of 0 N/cm.

A distance between the lamination roller 74 and the backup roller 44 is equal to or longer than the length of the total thickness of the flexible support W, an optical functional layer formed by curing the coating C by polymerization, and the film F and is preferably equal to or shorter than a length obtained by adding 5 mm to the total thickness. By setting the distance between the lamination roller 74 and the backup roller 44 to be equal to or shorter than the length obtained by adding 5 mm to the total thickness, it is possible to suppress intrusion of bubbles between the film F and the coating C. Herein, the distance between the lamination roller 74 and the backup roller 44 refers to the shortest distance between the outer peripheral surface of the lamination roller 74 and the outer peripheral surface of the backup roller 44.

In order to suppress thermal deformation after the coating C is sandwiched between the flexible support W and the film F, a difference between the temperature of the backup roller 44 and the temperature of the flexible support W, and a difference between the temperature of the backup roller 44 and the temperature of the film F are preferably 30° C. or lower, and more preferably 15° C. or lower, and most preferably, the temperatures are the same.

The flexible support W may be heated with the backup roller 44 by winding the flexible support W around the backup roller 44 whose temperature is adjusted. On the other hand, the film F can be heated with the lamination roller 74 by using the lamination roller 74 as a heat roller for the film. However, the temperature adjustment of the backup roller 44 and the heat roller of the lamination roller 74 are not required and can be provided if necessary.

As described above, by laminating the coating C formed by applying the coating solution to the flexible support W on the film F, a chance of contact of the coating C with external air is reduced and performance deterioration of the quantum dot can be reduced.

(Curing Device)

An optical functional layer can be obtained by polymerizing and curing the coating C by actinic ray irradiation after forming the laminated film LF by laminating the film F on the coated film CF. The curing condition can be appropriately set according to the kind of the curable compound to be used or the composition of a coating solution.

As shown in FIG. 1, the curing device 20 is a device which irradiates the coated surface with an actinic ray and cures the coating C for obtaining an optical functional layer. The curing device 20 includes the backup roller 44 also used in the coating device 14, and the lamination device 18, and as seen from the rotation direction of the backup roller 44, an actinic ray irradiation device 76 arranged on the downstream side of the lamination device 18 to be opposite to the backup roller 44. Then, the laminated film LF is continuously transported between the backup roller 44 and the actinic ray irradiation device 76.

The actinic ray emitted from the actinic ray irradiation device 76 may be determined according to the kind of the curable compound included in the coating solution and for example, ultraviolet rays may be used. For example, as a light source for generating ultraviolet rays, a low pressure mercury lamp, an intermediate pressure mercury lamp, a high pressure mercury lamp, an ultrahigh pressure mercury lamp, a carbon-arc lamp, a metal halide lamp, a xenon lamp, a light emitting diode (LED), laser, and the like can be used. The actinic ray irradiation dose may be set to be in a range in which polymerization and curing of the coating C can proceed, and for example, the coating C can be irradiated with ultraviolet rays at an irradiation dose of 10 to 10000 mJ/cm². The actinic ray irradiation dose to the coating C is preferably 10 to 1000 mJ/cm² and more preferably 50 to 800 mJ/cm².

The actinic ray irradiation atmosphere of the actinic ray irradiation device 76 is preferably a low oxygen atmosphere formed by nitrogen purge or the like.

In addition, the temperature of the backup roller 44 can be determined in consideration of heat generation at actinic ray irradiation, the curing efficiency of the coating C, and the generation of wrinkle deformation of the laminated film LF on the backup roller 44. For example, the temperature of the backup roller 44 is preferably set to be in a temperature range of 10° C. to 95° C., and more preferably set to be in a temperature range of 15° C. to 85° C. Herein, the temperature of the backup roller refers to the surface temperature of the backup roller.

By performing curing on the backup roller 44, which is the same roller for performing coating and lamination, as described above, while maintaining a state in which the laminated film LF is supported by the backup roller 44 without being slackened, the coated surface is irradiated with an actinic ray and cured. Thus, wrinkle generation in a functional film FF to be produced can be reduced and the performance of the functional film FF can be further improved.

In a case where the coating device 14, the lamination device 18, and the curing device 20 are arranged above the backup roller 44, the diameter of the backup roller is preferably in a range of 150 to 800) mm.

In the embodiment, the method of performing the polymerization treatment by actinic ray irradiation is described but in a case where the curable compound included in the coating solution is cured by heating (thermosetting compound), a curing device which performs a heating treatment can be used.

In addition, in the embodiment, the curing device 20 is arranged above the backup roller 44 as in the case of the coating device 14 and the lamination device 18 but there is no limitation thereto. The laminated film LF is formed by sandwiching the coating C between the flexible support W and the film F by the lamination device 18 to protect the coating C from external air (oxygen in external air). Accordingly, the curing device 20 can be arranged on a roller subsequent to the backup roller 44, for example, a pass roller.

### Other Embodiments of Inert Gas Supply Means and Reduced Pressure Chamber

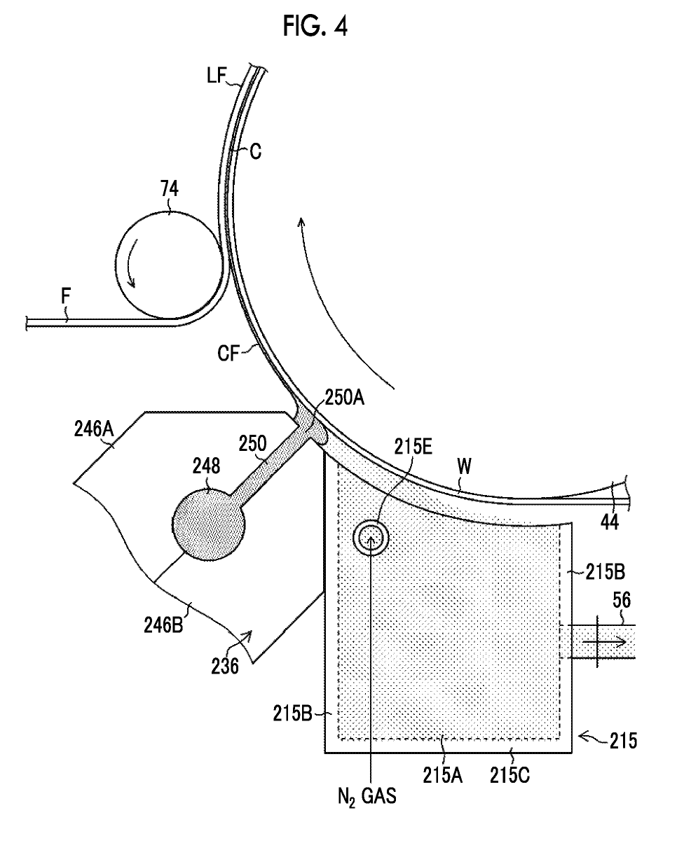

FIG. 4 is a view illustrating other embodiments of the inert gas supply device and the reduced pressure chamber. The inert gas supply device shown in FIG. 4 is different from the inert gas supply means and the reduced pressure chamber shown in FIGS. 1 and 2 in that an inert gas to be supplied to a reduced pressure chamber 215 is provided on a side plate 215A of the reduced pressure chamber 215.

According to the inert gas supply means and the reduced pressure chamber shown in FIG. 4, a manifold and a slit for supplying an inert gas are not required to be formed in a die coater. Thus, a die coater 236 includes two die blocks 246A and 246B, and a manifold 248, a slit 250, and a discharging port 250A for discharging a coating solution are formed.

The reduced pressure chamber 215 is formed by a pair of side plates 215A and 215A, a pair of back plates 215B and 215B, and a bottom plate 215C. An inert gas supply port 215E for supplying an inert gas is provided on the side plate 215A of the reduced pressure chamber 215. By supplying an inert gas from the side plate 215A of the reduced pressure chamber 215, the inside of the reduced pressure chamber 215 can be put under an inert gas atmosphere. The position of the inert gas supply port 215E on the side plate 215A is preferably provided at a position closet to the position where the coating solution is applied by the die coater 236 (hereinafter, also referred to as “coating position”). A gap is formed between the reduced pressure chamber 215 and the flexible support W and the pressure in the reduced pressure chamber 215 is reduced to cause the air to enter the reduced pressure chamber from the gap. By providing the inert gas supply port 215E at a position close to the coating position, the coating position can be put under an inert gas atmosphere, that is, around the bead, and thus contact with air (oxygen in the air) can be suppressed.

In addition, in FIG. 4, a configuration in which air is sucked by providing the inert gas supply port 215E at a position close to the coating position and providing the pipe 56 on the back plate 215B is described but the supply position may be opposite to the suction position. That is, the inert gas may be supplied from the pipe 56 provided on the back plate 215B and a pipe which sucks gas may be provided at the position of the inert gas supply port 215E shown in FIG. 4. Even in the configuration, the inert gas supplied from the pipe provided on the back plate 215B flows around the bead, forms an inert gas atmosphere, and exhausted, and thus contact with the coating solution and oxygen can be suppressed.

[Method for Producing Functional Film]

Next, a method for producing a functional film FF having an optical functional layer with a coating solution containing a quantum dot and substantially not including a volatile organic solvent using the apparatus 10 for producing a functional film according to the embodiment of the present invention configured as described above will be described. The expression “substantially not including a volatile organic solvent” means that a ratio of the volatile organic solvent in the coating solution is 10000 ppm or less.

(Coating Solution Preparation Step)

In a coating solution preparation step, each of components of a quantum dot (or a quantum rod), a curable compound, a thixotropic agent, a polymerization initiator, a silane coupling agent, and the like is mixed in a tank or the like to prepare a functional layer forming coating solution.

<Quantum Dot and Quantum Rod>

A quantum dot is a fine particle of a compound semiconductor having a size of several nm to several tens of nm and is at least excited by incidence exciting light to emit fluorescent light.

The quantum dot included in the coating solution of the embodiment can include at least one quantum dot, or also two or more quantum dots having different light emission properties. A known quantum dot includes a quantum dot (A) having a center emission wavelength in the wavelength range in the range of 600 nm to 680 nm, a quantum dot (B) having a center emission wavelength in the wavelength range in the range of 500 nm to 600 nm, and a quantum dot (C) having a center emission wavelength in the wavelength range in the range of 400 nm to 500 nm. The quantum dot (A) is excited by exciting light to emit red light, the quantum dot (B) is excited by exciting light to emit green light and the quantum dot (C) is excited by exciting light to emit blue light. For example, in a case where blue light is incident as exciting light on an optical functional layer including the quantum dots (A) and the quantum dot (B), white light can be can realized by red light emitted from the quantum dot (A), green light emitted from the quantum dot (B) and blue light penetrating through the optical functional layer. Alternatively, in a case where ultraviolet light can be incident as exciting light on a functional film having an optical functional layer including the quantum dots (A), (B) and (C), white light can be can realized by red light emitted from the quantum dot (A), green light emitted from the quantum dot (B) and blue light emitted from the quantum dot (C).

With respect to the quantum dot, those described in, for example, paragraphs 0060 to 0066 in JP2012-169271A can be referenced, but the quantum dot is not limited to those. For the quantum dot, a commercially available product can be used without any limitation. The emission wavelength of the quantum dot can be usually adjusted by the composition and the size of a particle.

The quantum dot can be added in an amount of, for example, about 0.1 to 10 parts by mass with respect to 100 parts by mass of the total amount of the coating solution.

The quantum dot may be added to the coating solution in the form of a particle and may be added to the polymerizable composition in the form of a dispersion liquid in which the quantum dots are dispersed in an organic solvent. It is preferable to add the quantum dot in the form of a dispersion liquid from the viewpoint of suppressing aggregation of quantum dot particles. The organic solvent used to disperse the quantum dots is not particularly limited.

However, it is preferable that the content of the volatile organic solvent in the coating solution supplied to the coating device 14 is reduced to 10000 ppm or less and preferably reduced to 1000 ppm or less.

Therefore, in a case where the quantum dots are added to the coating solution in the form of a dispersion liquid in which the quantum dots are dispersed in the organic solvent, it is required to dry the organic solvent in the coating solution before the coating solution is applied to the flexible support W. That is, at the time when the coating solution is supplied to the coating device 14, the coating solution does not substantially include the organic solvent.

A volatile organic solvent refers to a compound which has a boiling point of 160° C. or lower, is not cured by the curable compound in the coating solution and external stimulus, and is in a liquid state at 20° C. The boiling point of the volatile organic solvent is more preferably 115° C. or lower, and most preferably 30° C. or higher and 100° C. or lower.

Setting the content of the organic solvent in the coating solution to 10000 ppm or less can be performed by using no organic solvent in preparation of the coating solution, or drying the organic solvent in the coating solution. As a method for drying the organic solvent in the coating solution, any method may be used as long as the ratio of the volatile organic solvent in the coating solution can be set to 10000 ppm or less. For example, as shown in FIG. 1, by reducing the pressure in the tank 26 with the pressure reducing pipe 33, the organic solvent can be volatilized. In addition, the organic solvent can be volatilized by an operation of substituting air (oxygen) in the coating solution by nitrogen gas in the tank 26 of the dissolved oxygen reducing device 12. In this case, it is preferable to provide heating means in the tank 26 so as to make volatilization of the organic solvent easy.

A quantum rod can be used instead of the quantum dot. The quantum rod is a particle having an elongated rod shape and has the same properties as those of the quantum dot. The amount of the quantum rod to be added and the method for adding the quantum rod to the coating solution may be the same as the amount of the quantum dot and the method for adding the quantum dot, respectively. The quantum dot and the quantum rod can also be used in combination.

<Curable Compound>

As the curable compound used in the embodiment, a compound having a polymerizable group may be adopted. The kind of the polymerizable group is not particularly limited and the polymerizable group is preferably a (meth)acrylate group, a vinyl group, or an epoxy group, more preferably a (meth)acrylate group, and still more preferably an acrylate group. In addition, with respect to a polymerizable monomer having two or more polymerizable groups, the respective polymerizable groups may be the same or different.

—(Meth)Acrylate-Based—

From the viewpoint of transparency, adhesiveness and the like of a cured coated film after curing, a (meth)acrylate compound such as a monofunctional or polyfunctional (meth)acrylate monomer, a polymer or prepolymer thereof, or the like is preferable. In the present invention and specification, the term “(meth)acrylate” is used to mean at least one or any one of acrylate and methacrylate. The same applies to the term “(meth)acryloyl” and the like.

—Bifunctional Monomer—

As a polymerizable monomer having two polymerizable groups, for example, a bifunctional polymerizable unsaturated monomer having two ethylenically unsaturated bond-containing groups can be used. The bifunctional polymerizable unsaturated monomer is suitable for allowing a composition to have a low viscosity. In the embodiment, a (meth)acrylate-based compound having excellent reactivity and having no problems such as a remaining catalyst is preferable.

In particular, neopentyl glycol di(meth)acrylate, 1,9-nonanediol di(meth)acrylate, dipropylene glycol di(meth)acrylate, tripropylene glycol di(meth)acrylate, tetraethylene glycol di(meth)acrylate, hydroxypivalate neopentyl glycol di(meth)acrylate, polyethylene glycol di(meth)acrylate, dicyclopentenyl(meth)acrylate, dicyclopentenyl oxyethyl(meth)acrylate, dicyclopentanyl di(meth)acrylate, or the like is suitably used in the present invention.

The amount of the bifunctional (meth)acrylate monomer to be used is preferably 5 parts by mass or more and more preferably 10 to 80 parts by mass with respect to 100 parts by mass of the total amount of the curable compound included in the coating solution from the viewpoint of adjusting the viscosity of the coating solution to be in a preferable range.

—Tri- or Higher Functional Monomer—

As a polymerizable monomer having three or more polymerizable groups, for example, a polyfunctional polymerizable unsaturated monomer having three or more ethylenically unsaturated bond-containing groups can be used. The polyfunctional polymerizable unsaturated monomer is preferable from the viewpoint of imparting mechanical strength. In the embodiment, a (meth)acrylate-based compound having excellent reactivity and having no problem of a remaining catalyst is preferable.

Specifically, epichlorohydrin (ECH)-modified glycerol tri(meth)acrylate, ethylene oxide (EO)-modified glycerol tri(meth)acrylate, propylene oxide (PO)-modified glycerol tri(meth)acrylate, pentaerythritol triacrylate, pentaerythritol tetraacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl)isocyanurate, dipentaerythritol hexa(meth)acrylate, dipentaerythritol penta(meth)acrylate, caprolactone-modified dipentaerythritol hexa(meth)acrylate, dipentaerythritol hydroxy penta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy tetra(meth)acrylate, or pentaerythritol tetra(meth)acrylate is suitable.

Among these, in particular, EO-modified glycerol tri(meth)acrylate, PO-modified glycerol tri(meth)acrylate, trimethylolpropane tri(meth)acrylate, EO-modified trimethylolpropane tri(meth)acrylate, PO-modified trimethylolpropane tri(meth)acrylate, dipentaerythritol hexa(meth)acrylate, dipentaerythritol penta(meth)acrylate, pentaerythritolethoxy tetra(meth)acrylate, or pentaerythritol tetra(meth)acrylate is suitably used in the present invention.

The amount of the polyfunctional (meth)acrylate monomer to be used is preferably 5 parts by mass or more with respect to 100 parts by mass of the total amount of the curable compound included in the coating solution from the viewpoint of the coated film hardness of an optical functional layer after curing, and more preferably 95 parts by mass or less with respect to 100 parts by mass of the total amount of the curable compound from the viewpoint of suppressing gelation of the coating solution.

—Monofunctional Monomer—

As the monofunctional (meth)acrylate monomer, acrylic acid and methacrylic acid, and derivatives thereof, more specifically, a monomer having one polymerizable unsaturated bond ((meth)acryloyl group) of (meth)acrylic acid in one molecule may be used. Specific examples thereof include the following compounds, but the present embodiment is not limited thereto.

Examples thereof include alkyl(meth)acrylates having 1 to 30 carbon atoms in the alkyl group, such as methyl(meth)acrylate, n-butyl(meth)acrylate, isobutyl(meth)acrylate, 2-ethylhexyl(meth)acrylate, isononyl(meth)acrylate, n-octyl(meth)acrylate, lauryl(meth)acrylate and stearyl(meth)acrylate; aralkyl(meth)acrylates having 7 to 20 carbon atoms in the aralkyl group, such as benzyl(meth)acrylate; alkoxyalkyl(meth)acrylates having 2 to 30 carbon atoms in the alkoxyalkyl group, such as butoxyethyl(meth)acrylate; aminoalkyl(meth)acrylates having 1 to 20 carbon atoms in total in the (monoalkyl or dialkyl)aminoalkyl group, such as N,N-dimethylaminoethyl(meth)acrylate; polyalkylene glycol alkyl ether(meth)acrylates having 1 to 10 carbon atoms in the alkylene chain and having 1 to 10 carbon atoms in the terminal alkyl ether, such as diethylene glycol ethyl ether(meth)acrylate, triethylene glycol butyl ether(meth)acrylate, tetraethylene glycol monomethyl ether(meth)acrylate, hexaethylene glycol monomethyl ether(meth)acrylate, octaethylene glycol monomethyl ether(meth)acrylate, nonaethylene glycol monomethyl ether(meth)acrylate, dipropylene glycol monomethyl ether(meth)acrylate, heptapropylene glycol monomethyl ether(meth)acrylate and tetraethylene glycol monoethyl ether(meth)acrylate; polyalkylene glycol aryl ether(meth)acrylates having 1 to 30 carbon atoms in the alkylene chain and having 6 to 20 carbon atoms in the terminal aryl ether, such as hexaethylene glycol phenyl ether(meth)acrylate; (meth)acrylate having an alicyclic structure and having 4 to 30 carbon atoms in total, such as cyclohexyl(meth)acrylate, dicyclopentanyl(meth)acrylate, isobornyl(meth)acrylate and methylene oxide addition cyclodecatriene(meth)acrylate; fluorinated alkyl(meth)acrylates having 4 to 30 carbon atoms in total, such as heptadecafluorodecyl(meth)acrylate; (meth)acrylates having a hydroxyl group, such as 2-hydroxyethyl(meth)acrylate, 3-hydroxypropyl(meth)acrylate, 4-hydroxybutyl(meth)acrylate, triethylene glycol mono(meth)acrylate, tetraethylene glycol mono(meth)acrylate, hexaethylene glycol mono(meth)acrylate, octapropylene glycol mono(meth)acrylate and glycerol mono or di(meth)acrylate; (meth)acrylates having a glycidyl group, such as glycidyl(meth)acrylate; polyethylene glycol mono(meth)acrylates having 1 to 30 carbon atoms in the alkylene chain, such as tetraethylene glycol mono(meth)acrylate, hexaethylene glycol mono(meth)acrylate and octapropylene glycol mono(meth)acrylate; and (meth)acrylamides such as (meth)acrylamide, N,N-dimethyl(meth)acrylamide, N-isopropyl(meth)acrylamide, 2-hydroxyethyl(meth)acrylamide and acryloylmorpholine.

The amount of the monofunctional (meth)acrylate monomer to be used is preferably 10 parts by mass or more, and more preferably 10 to 80 parts by mass with respect to 100 parts by mass of the total amount of the curable compound included in the coating solution from the viewpoint of adjusting the viscosity of the coating solution in a preferable range.

—Epoxy-Based Compound and Others—

As the polymerizable monomer used in the embodiment, a compound having a cyclic group such as a ring-opening polymerizable cyclic ether group such as an epoxy group and an oxetanyl group may be used. As such a compound, more preferably, a compound having an epoxy group (epoxy compound) may be used. By using the compound having an epoxy group or an oxetanyl group in combination with the (meth)acrylate-based compound, adhesiveness with a barrier layer tends to be improved.

Examples of the compound having an epoxy group can include polyglycidyl esters of polybasic acid, polyglycidyl ethers of polyhydric alcohol, polyglycidyl ethers of polyoxyalkylene glycol, polyglycidyl ethers of aromatic polyol, hydrogenated compounds of polyglycidyl ethers of aromatic polyol, urethane polyepoxy compounds, and epoxidized polybutadienes. These compounds can be used alone or as a mixture of two or more.

Examples of other compound having an epoxy group, which can be preferably used, can include aliphatic cyclic epoxy compounds, bisphenol A diglycidyl ethers, bisphenol F diglycidyl ethers, bisphenol S diglycidyl ethers, brominated bisphenol A diglycidyl ethers, brominated bisphenol F diglycidyl ethers, brominated bisphenol S diglycidyl ethers, hydrogenerated bisphenol A diglycidyl ethers, hydrogenerated bisphenol F diglycidyl ethers, hydrogenerated bisphenol S diglycidyl ethers, 1,4-butanediol diglycidyl ethers, 1,6-hexanediol diglycidyl ethers, glycerin triglycidyl ethers, trimethylolpropane triglycidyl ethers, polyethylene glycol diglycidyl ethers and polypropylene glycol diglycidyl ethers; polyglycidyl ethers of polyether polyol, obtained by adding one, or two or more alkylene oxides to an aliphatic polyhydric alcohol such as ethylene glycol, propylene glycol or glycerin; diglycidyl esters of aliphatic long chain dibasic acid; monoglycidyl ethers of aliphatic higher alcohol; monoglycidyl ethers of polyether alcohol, obtained by adding an alkylene oxide to phenol, cresol, butyl phenol or these phenols; and glycidyl esters of higher fatty acid.

Among these components, aliphatic cyclic epoxy compounds, bisphenol A diglycidyl ethers, bisphenol F diglycidyl ethers, hydrogenerated bisphenol A diglycidyl ethers, hydrogenerated bisphenol F diglycidyl ethers, 1,4-butanediol diglycidyl ethers, 1,6-hexanediol diglycidyl ethers, glycerin triglycidyl ethers, trimethylolpropane triglycidyl ethers, neopentyl glycol diglycidyl ethers, polyethylene glycol diglycidyl ethers, and polypropylene glycol diglycidyl ethers are preferable.

Examples of a commercially available product, which can be suitably used as the compound having an epoxy group or an oxetanyl group, include UVR-6216 (manufactured by Union Carbide Corporation), glycidol, AOEX24, CYCLOMER A200, CELLOXIDE 2021P and CELLOXIDE 8000 (trade names, these manufactured by Daicel Corporation), 4-vinylcyclohexene dioxide manufactured by Sigma Aldrich, EPIKOTE 828, EPIKOTE 812, EPIKOTE 1031, EPIKOTE 872 and EPIKOTE CT508 (registered trade name: EPIKOTE, these manufactured by Yuka Shell Epoxy K.K.), and KRM-2400, KRM-2410, KRM-2408, KRM-2490, KRM-2720 and KRM-2750 (trade names, these manufactured by Adeka Corporation). These can be used alone or in a combination of two or more.

In addition, regarding these compounds having an epoxy group or an oxetanyl group, any production method thereof may be adopted and the compounds having an epoxy group or an oxetanyl group can be synthesized with reference to Literatures such as “Fourth Edition Experimental Chemistry Course 20 Organic Synthesis II”, p. 213, 1992, published by Maruzen KK; Ed. by Alfred Hasfner, “The chemistry OF heterocyclic compounds-Small Ring Heterocycles part 3 Oxiranes”, John & Wiley and Sons, An Interscience Publication, New York, 1985, Yoshimura, “Bonding”, vol. 29, No. 12, 32, 1985, Yoshimura, “Bonding”, vol. 30, No. 5, 42, 1986, Yoshimura, “Bonding”, vol. 30, No. 7, 42, 1986, JP1999-100378A (JP-H11-100378A), JP2906245B, and JP2926262B.

As the curable compound used in the embodiment, a vinyl ether compound may also be used.

As the vinyl ether compound, a known vinyl ether compound can be appropriately selected, and, for example, one described in paragraph 0057 in JP2009-73078A can be preferably adopted.

These vinyl ether compounds can be synthesized by, for example, the method described in Stephen. C. Lapin, “Polymers Paint Colour Journal”, 179 (4237), 321 (1988), namely, by a reaction of a polyhydric alcohol or a polyhydric phenol with acetylene, or a reaction of a polyhydric alcohol or a polyhydric phenol with a halogenated alkyl vinyl ether, and such method and reactions can be used alone or in combination of two or more.

For the coating solution of the embodiment, a silsesquioxane compound having a reactive group described in JP2009-73078A can also be used from the viewpoint of a decrease in viscosity and an increase in hardness.

<Thixotropic Agent>

The thixotropic agent is an inorganic compound or an organic compound.

—Inorganic Substance—

One preferable aspect of the thixotropic agent is a thixotropic agent of an inorganic substance, and, for example, a needle-like compound, a chain-like compound, a flattened compound or a layered compound can be preferably used. Among these, a layered compound is preferable.

The layered compound is not particularly limited, and examples thereof include talc, mica, feldspar, kaolinite (kaolin clay), pyrophyllite (pyrophyllite clay), sericite, bentonite, smectite and vermiculite (montmorillonite, beidellite, non-tronite, saponite and the like), organic bentonite, and organic smectite.

These can be used alone or in a combination of two or more. Examples of a commercially available layered compound include, as inorganic compounds, CROWN CLAY, BURGESS CLAY #60, BURGESS CLAY KF and OPTIWHITE (trade names, these manufactured by Shiraishi Kogyo Kaisha Ltd.), KAOLIN JP-100, NN KAOLIN CLAY, ST KAOLIN CLAY and HARDSIL (trade names, these manufactured by Tsuchiya Kaolin Ind., Ltd.), ASP-072, SATINTONPLUS, TRANSLINK 37 and HYDROUSDELAMI NCD (trade names, these manufactured by Angel Hard Corporation), SY KAOLIN, OS CLAY, HA CLAY and MC HARD CLAY (trade names, these manufactured by Maruo Calcium Co., Ltd.), RUCENTITE SWN, RUCENTITE SAN, RUCENTITE STN, RUCENTITE SEN AND RUCENTITE SPN (trade names, these manufactured by Co-op Chemical Co., Ltd.), SUMECTON (trade name, manufactured by Kunimine Industries Co., Ltd.), Bengel, BENGEL FW, ESBEN, ESBEN 74, ORGANITE AND ORGANITE T (trade names, these manufactured by Hojun Co., Ltd.), HODAKA JIRUSHI, ORBEN, 250M, BENTONE 34 AND BENTONE 38 (trade names, these manufactured by Wilbur-Ellis Company), and LAPONITE, LAPONITE RD AND LAPONITE RDS (trade names, these manufactured by Nippon Silica Industrial Co., Ltd.). These compounds may also be dispersed in a solvent.

The thixotropic agent to be added to the coating solution is, among the layered inorganic compounds, a silicate compound represented by xM(I)₂O.ySiO₂ (also including a compound corresponding to M(II)O or M(III)₂O₃ having an oxidation number of 2 or 3; x and y represent a positive number), and a further preferable compound is a swellable layered clay mineral such as hectorite, bentonite, smectite or vermiculite.

Particularly preferably, a layered (clay) compound modified by an organic cation (a silicate compound in which an interlayer cation such as sodium is exchanged with an organic cation compound) can be suitably used, and examples thereof include sodium magnesium silicate (hectorite) in which a sodium ion is exchanged with an ammonium ion described below.

Examples of the ammonium ion include a monoalkyltrimethylammonium ion, a dialkyldimethylammonium ion and a trialkylmethylammonium ion having an alkyl chain having 6 to 18 carbon atoms, a dipolyoxyethylene-palm-oil-alkylmethylammonium ion and a bis(2-hydroxyethyl)-palm-oil-alkylmethylammonium ion having 4 to 18 oxyethylene chains, and a polyoxypropylene methyldiethylammonium ion having 4 to 25 oxopropylene chains. These ammonium ions can be used alone or in a combination of two or more.

The method for producing an organic cation-modified silicate mineral in which a sodium ion of sodium magnesium silicate is exchanged with an ammonium ion is such that sodium magnesium silicate is dispersed in water and sufficiently stirred, and thereafter left to still stand for 16 hours or more to prepare a 4% by mass dispersion liquid. While this dispersion liquid is stirred, a desired ammonium salt is added in an amount of 30% by mass to 200% by mass relative to sodium magnesium silicate. After the addition, cation exchange occurs to allow hectorite including an ammonium salt between layers to be insoluble in water and precipitated, and thus the precipitate is taken by filtration and dried. In the preparation, heating may also be performed for the purpose of accelerating the dispersion.

A commercially available product of the alkylammonium-modified silicate mineral includes RUCENTITE SAN. RUCENTITE SAN-316, RUCENTITE STN, RUCENTITE SEN and RUCENTITE SPN (trade names, these manufactured by Co-op Chemical Co., Ltd.), and these can be used alone or in a combination of two or more.

In the embodiment, silica, alumina, silicon nitride, titanium dioxide, calcium carbonate, zinc oxide or the like can be used for the thixotropic agent of an inorganic substance. Such a compound can also be if necessary subjected to a treatment for regulation of hydrophilicity or hydrophobicity of the surface.

—Organic Substance—

For the thixotropic agent, a thixotropic agent of an organic substance can be used.

Examples of the thixotropic agent of an organic substance include an oxidized polyolefin and a modified urea.

The above-oxidized polyolefin may be independently prepared, or a commercially available product may be used. Examples of the commercially available product include DISPERLON 4200-20 (trade name, manufactured by Kusumoto Chemicals, Ltd.) and FLOWNON SA300 (trade name, manufactured by Kyoeisha Chemical Co., Ltd.).

The modified urea described above is a reaction product of an isocyanate monomer or an adduct thereof with an organic amine. The modified urea described above may be independently prepared or a commercially available product may be used. Examples of the commercially available product include BYK 410 (manufactured by BYK Japan K.K.).

—Content—

The content of the thixotropic agent is preferably 0.15 to 20 parts by mass, more preferably 0.2 to 10 parts by mass, and particularly preferably 0.2 to 8 parts by mass with respect to 100 parts by mass of the curable compound in the coating solution. In particular, in a case of the thixotropic agent of an inorganic compound, brittleness tends to be improved at a content of 20 parts by mass or less with respect to 100 parts by mass of the curable compound.

<Polymerization Initiator>

The coating solution can include a known polymerization initiator as the polymerization initiator. With respect to the polymerization initiator, for example, paragraph 0037 in JP2013-043382A can be referred to. The amount of the polymerization initiator is preferably 0.1% by mol or more and more preferably 0.5% to 2% by mol with respect to the total amount of the curable compound included in the coating solution. In addition, the amount of the polymerization initiator is preferably 0.1% to 10% by mass and more preferably 0.2% to 8% by mass as the percentage by mass in the entire curable composition excluding the volatile organic solvent.

<Silane Coupling Agent>

The optical functional layer formed of the coating solution including a silane coupling agent can exhibit excellent durability because of being strong in adhesiveness to an adjacent layer due to the silane coupling agent. In addition, the optical functional layer formed of the coating solution including a silane coupling agent is preferable since an adhesiveness condition relationship of adhesiveness A between the flexible support and a barrier layer <adhesiveness B between the optical functional layer and a barrier layer is established. This is mainly because the silane coupling agent included in the optical functional layer forms a covalent bond with the surface of an adjacent layer or the constitutional component of the optical functional layer through a hydrolysis reaction or condensation reaction. In addition, in a case where the silane coupling agent has a reactive functional group such as a radical polymerizable group, formation of a crosslinking structure with the monomer component constituting the optical functional layer can also contribute to improvement in adhesiveness between an adjacent layer and the optical functional layer.

For the silane coupling agent, a known silane coupling agent can be used without any limitation. A preferable silane coupling agent in terms of adhesiveness can include a silane coupling agent represented by Formula (1) described in JP2013-43382A.

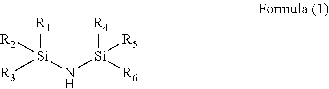

(In Formula (1). R₁ to R₆ each independently represent a substituted or unsubstituted alkyl group or aryl group. Herein, at least one of R₁ to R₆ represents a substituent including a radical polymerizable carbon-carbon double bond.)

R₁ to R₆ each independently represent a substituted or unsubstituted alkyl group or aryl group. Except for a case where R₁ to R₆ represent a substituent including a radical polymerizable carbon-carbon double bond, the alkyl group is preferably an unsubstituted alkyl group or unsubstituted aryl group. The alkyl group is preferably an alkyl group having 1 to 6 carbon atoms, and more preferably a methyl group. The aryl group is preferably a phenyl group. R₁ to R₆ each particularly preferably represent a methyl group.

At least one of R₁ to R₆ has a substituent including a radical polymerizable carbon-carbon double bond, and two of R₁ to R₆ preferably have a substituent including a radical polymerizable carbon-carbon double bond. Furthermore, it is particularly preferable that one of R₁ to R₃ has a substituent including a radical polymerizable carbon-carbon double bond and one of R₄ to R₆ has a substituent including a radical polymerizable carbon-carbon double bond.

In a case where the silane coupling agent represented by Formula (1) has two or more substituents including a radical polymerizable carbon-carbon double bond, the respective substituents may be the same or different, and are preferably the same.

It is preferable that the substituent including a radical polymerizable carbon-carbon double bond is represented by —X—Y. Herein, X represents a single bond, an alkylene group having 1 to 6 carbon atoms, or an arylene group, preferably represents a single bond, a methylene group, an ethylene group, a propylene group or a phenylene group. Y represents a radical polymerizable carbon-carbon double bond group, preferably an acryloyloxy group, a methacryloyloxy group, an acryloylamino group, a methacryloylamino group, a vinyl group, a propenyl group, a vinyloxy group or a vinylsulfonyl group, and more preferably a (meth)acryloyloxy group.

R₁ to R₆ may also have a substituent other than the substituent including a radical polymerizable carbon-carbon double bond. Examples of such a substituent include alkyl groups (such as a methyl group, an ethyl group, an isopropyl group, a tert-butyl group, a n-octyl group, a n-decyl group, a n-hexadecyl group, a cyclopropyl group, a cyclopentyl group and a cyclohexyl group), aryl groups (such as a phenyl group and a naphthyl group), halogen atoms (such as fluorine, chlorine, bromine and iodine), acyl groups (such as an acetyl group, a benzoyl group, a formyl group and a pivaloyl group), acyloxy groups (such as an acetoxy group, an acryloyloxy group and a methacryloyloxy group), alkoxycarbonyl groups (such as a methoxycarbonyl group and an ethoxycarbonyl group), aryloxycarbonyl groups (such as a phenyloxycarbonyl group), and sulfonyl groups (such as a methanesulfonyl group and a benzenesulfonyl group).

The content of the silane coupling agent in the coating solution is preferably 1% to 30% by mass, more preferably 3 to 30% by mass, and particularly preferably 5% to 25% by mass from the viewpoint of further improvement in adhesiveness to the adjacent layer.

(Dissolved Oxygen Reduction Step)

Next, the coating solution prepared in the coating solution preparation step is adjusted such that the dissolved oxygen concentration in the coating solution is 1000 ppm or less by the dissolved oxygen reducing device 12. In a case where the dissolved oxygen concentration in the coating solution prepared in the coating solution preparation step is 1000 ppm or less, the dissolved oxygen reduction step can be omitted or the dissolved oxygen concentration can be further reduced by the dissolved oxygen reduction step.

In the dissolved oxygen reduction step, the coating solution prepared in the coating solution preparation step is supplied into the tank 26. In this case, it is preferable that nitrogen gas is supplied into the tank 26 from the nitrogen gas pipe 30 and air in the tank 26 is substituted by nitrogen gas in advance before the coating solution is supplied into the tank 26.

While nitrogen gas is being supplied into the tank 26 from the nitrogen gas pipe 30, the coating solution in the tank 26 is stirred by the stirrer 32 and the dissolved oxygen dissolved in the coating solution is changed to nitrogen gas. Thus, the concentration of dissolved oxygen dissolved in the coating solution is preferably reduced to 1000 ppm or less, more preferably reduced to 500 ppm or less, and particularly preferably reduced to 100 ppm or less.

Whether or not the dissolved oxygen concentration in the coating solution is 1000 ppm or less can be measured using a dissolved oxygen meter (not shown) by sampling the coating solution from the tank 26 without contact with external air. In addition, although not shown in the drawing, the dissolved oxygen concentration in the coating solution may be automatically measured by attaching a bypass pipe for measurement to the tank 26 and attaching a dissolved oxygen meter to the bypass pipe.

In a case where the volatile organic solvent is used as a dispersion liquid for the quantum dot, the ratio of the organic solvent is preferably set to 10000 ppm or less and more preferably set to 1000 ppm or less by performing stirring operation of nitrogen gas substitution and operating the vacuum device connected to the pressure reducing pipe 33.

Next, the liquid feeding pump 40 is operated to feed the coating solution in the tank 26 to the manifold 48 of the die coater 36. In this case, it is preferable that nitrogen gas is blown into the liquid feeding pipe 38 from the nitrogen gas blowing pipe 42 before the coating solution in which the dissolved oxygen is reduced by the dissolved oxygen reducing device 12 is fed to the die coater 36 of the coating device 14. Thus, air in the liquid feeding pipe 38 and in the inside (manifold 48, slit 50) of the die coater 36 can be substituted by the nitrogen gas in advance.

Accordingly, while a state in which the dissolved oxygen in the coating solution is reduced to 1000 ppm or less in the dissolved oxygen reduction step is being maintained, the coating solution can be supplied to the die coater 36.

(Coating Step)

Next, in a coating step, the coating solution supplied to the manifold 48 of the die coater 36 is applied to the flexible support W which is transported in a state in which the support is wound around the backup roller 44 to form a coated film CF.

That is, the flow of the coating solution supplied to the manifold 48 is expanded in a coating width direction by the manifold 48, then flows along the slit 50, and is discharged from the slit discharging port 50A to the flexible support W to be transported. Thus, a coating solution bead is formed a clearance between the land 37 of the die coater 36 and the flexible support W.

The flexible support W is a belt-like support having a flexibility and is preferably, for example, a transparent support which is transparent to visible light. COSMOSHINE A4100 (trade name) manufactured by Toyobo Co., Ltd., which is a polyethylene terephthalate (PET) film with an easily adhesive layer, can be used.

The expression “transparent to visible light” herein refers to a light transmittance in the visible light region of 80% or more and preferably 85% or more. The light transmittance used for measuring transparency can be calculated according to the method described in JIS-K7105 (JIS: Japan Industrial Standards), that is, by measuring the total light transmittance and the amount of light to be scattered, by use of an integrating sphere light transmittance measuring apparatus, and subtracting the diffuse transmittance from the total light transmittance. With respect to the flexible support, paragraphs 0046 to 0052 in JP2007-290369A and paragraphs 0040 to 0055 in JP2005-096108A can be referred to. The thickness of the flexible support is preferably in a range of 10 to 500 μm, more preferably in a range of 15 to 100 μm, and still more preferably in a range of 25 to 60 μm, from the viewpoint of gas barrier properties, impact resistance, and the like.

In addition, flexible support W to be used is preferably a gas barrier film having excellent barrier properties to oxygen and the formation of the gas barrier film will be described in detail in the section of a gas barrier film forming apparatus which will be described later.

In the die coater 236 including two die blocks 246A and 246B shown in FIG. 4, the dissolved oxygen reduction step and the coating step can be also performed in the same manner, and the coating solution can be applied to the flexible support through the manifold 248 and the slit 250.

(Inert Gas Supply Step)

In an inert gas supply step, by the die block type inert gas supply device 16 shown in FIGS. 1 and 2 or supplying an inert gas from the inert gas supply port 215E provided on the side plate 215A of the reduced pressure chamber 215 shown in FIG. 4 and by sucking the inside of the reduced pressure chambers 15 and 215 by the blower, the pressure in the reduced pressure chamber is reduced.

By reducing the pressure in the reduced pressure chambers 15 and 215, a stable bead is formed and the coating solution can be applied to the flexible support W through the bead with high accuracy.

The die block type inert gas supply means supplies an inert gas to the manifold 52 of the die coater 36 and discharges the inert gas from the slit 54 to the flexible support W in a width direction. The discharged inert gas is discharged around the bead and thus the gas atmosphere around the bead can be set to an inert gas atmosphere. In addition, since the inside of the reduced pressure chamber 15 is sucked, the bead can be stabilized. Since the pressure in the reduced pressure chamber 15 is reduced while supplying the inert gas, it is preferable that the exhaust amount (suction amount) of the inert gas from the reduced pressure chamber 15 is larger than the supply amount of the inert gas. The supply amount of the inert gas can be controlled by the opening and closing valves 68A and 70A and the exhaust amount of the inert gas can be controlled by the blower 58.

The pressure reduction degree in the reduced pressure chamber 15 is preferably 10 Pa or more. Here, the pressure reduction degree means a difference between the inside pressure and the atmospheric pressure. In order to stabilize the coating bead, the pressure reduction degree is sufficiently set to 10 Pa or more. In addition, in a case where the pressure reduction degree too high, air easily enters the reduced pressure chamber from the gap between the flexible support W and the reduced pressure chamber 15 and the oxygen concentration in the reduced pressure chamber is not stabilized. Thus, this case is not preferable. The upper limit of the pressure reduction degree is preferably 2000 Pa or less.

As the inert gas, an inert gas of which the oxygen concentration is adjusted to less than 5000 ppm is preferably used. By using an inert gas having an adjusted oxygen concentration, the oxygen concentration in the reduced pressure chamber can be stabilized and the performance of a functional film to be produced can be stabilized. The adjusted oxygen concentration of the inert gas is preferably 3000 ppm or less and more preferably 1000 ppm or less. Adjustment of the oxygen concentration in the inert gas can be performed by measuring the concentration of a gas obtained by mixing the inert gas and oxygen with the measurement means 72 and by controlling the opening and closing valves 68A and 70A based on the measured value.

The supply amount of the inert gas to the reduced pressure chamber 15 is preferably 100 L/min/m or more and 10000 L/min/m or less. The unit “m” of the supply amount of the inert gas means a unit per 1 m width of the reduced pressure chamber.

In a case where the inert gas is supplied from the side plate 215A of the reduced pressure chamber 215 shown in FIG. 4, the inert gas can be supplied under the same conditions.

(Lamination Step)

Next, in a lamination step, the film F which is transported in a state in which the film is wound around the lamination roller 74 and the coated film CF which is transported in a state in which the film is wound around the backup roller 44 are interposed and nipped between the lamination roller 74 and the backup roller 44 to laminate the film F on the coated surface of the coated film CF.

Since a laminated film LF having a three layer structure in which the coating C is interposed between the flexible support W and the film F is formed in this manner, a chance of contact of the coating C with external air (oxygen in external air) can be reduced. Thus, it is possible to suppress performance deterioration of the quantum dot included in the coating by oxygen.

The film F used for lamination is preferably a gas barrier film having excellent barrier properties to oxygen as in the case of the flexible support W. The formation of the gas barrier film will be described in detail later.

(Curing Step)

In a curing step, while the laminated film LF in which the coating C is sandwiched between the flexible support W and the film F is being continuously transported onto the backup roller 44, irradiation with an actinic ray from the actinic ray irradiation device 76 is performed to cure the coating C. Thus, an optical functional layer is formed. In addition, since the curing step is performed on the backup roller 44, it is possible to reduce wrinkle generation in the produced functional film FF.

The functional film FF can be obtained through the above steps. The obtained functional film FF is peeled from the backup roller 44 by a peeling roller 78, then continuously transported to a winding machine (not shown), and rolled in a roll shape.

However, since easiness to degradation with respect to oxygen varies depending on materials whose performance is deteriorated by oxygen, in the method for producing a functional film according to the present invention, the film F to be laminated on the flexible support W and the coating C to which the coating solution is applied is not limited to a gas barrier film in which a gas barrier layer having barrier properties to oxygen is formed.

However, in a case where a material performance is deteriorated by oxygen is the quantum dot in the embodiment, it is preferable to use a gas barrier film as at least one of films F to be laminated on the flexible support W and the coating C to which the coating solution is applied.

The barrier layer may include at least an inorganic layer and may include at least one inorganic layer and at least one organic layer on a support for forming a gas barrier film. It is preferable to laminate a plurality of layers in this manner from the viewpoint of light resistance since the barrier properties can be further improved. On the other hand, as the number of laminated layers increases, the light transmittance of the optical functional layer tends to further decrease. Thus, it is desirable to increase the number of laminated layer in a range in which satisfactory light transmittance can be maintained.

Specifically, the total light transmittance of the barrier layer in a visible light range is preferably 80% or more and the oxygen permeability of the barrier layer is preferably 1.00 cm³/(m²·day·atm) or less. The total light transmittance refers to an average light transmittance value in a visible light range.

The oxygen permeability of the barrier layer is more preferably 0.1 cm³/(m²·day·atm) or less, particularly preferably 0.01 cm³/(m²·day·atm) or less, and more particularly preferably 0.001 cm³/(m²·day·atm) or less. Herein, the oxygen permeability is a value measured using an oxygen gas permeability measuring apparatus (trade name: OX-TRAN 2/20, manufactured by MOCON Inc.) under the conditions of a measurement temperature of 23° C. and a relative humidity of 90%. In addition, the visible light range refers to a wavelength range of 380 to 780 nm and the total light transmittance indicates an average light transmittance value excluding the contribution of light absorption and reflection of the optical functional layer.

The total light transmittance in the visible light range is more preferably 90% or more. The lower the oxygen permeability is, the more preferable it is, and the higher the total light transmittance in the visible light range is, the more preferable it is.

—Inorganic Layer—

The inorganic layer is a layer having an inorganic material as a main component and is preferably a layer formed of only an inorganic material.

The inorganic layer is preferably a layer having a gas barrier function of blocking oxygen. Specifically, the oxygen permeability of the inorganic layer is preferably 1.00 cm³/(m²·day·atm) or less. The oxygen transmission coefficient of the inorganic layer can be obtained by attaching a wavelength conversion layer to a detection portion of an oxygen concentration meter, manufactured by Orbisphere Laboratories, with silicon grease, and converting an average oxygen concentration value into an oxygen transmission coefficient. The inorganic layer preferably has a function of blocking water vapor.

Two or three or more inorganic layers may be included in the barrier layer.

The inorganic material constituting the inorganic layer is not particularly limited and for example, metal and various inorganic compounds such as inorganic oxide, nitride, and oxynitride can be used. As elements constituting the inorganic material, silicon, aluminum, magnesium, titanium, tin, indium, and cerium are preferable and one or two or more of these may be contained. Specific examples of the inorganic compound include silicon oxide, silicon oxynitride, aluminum oxide, magnesium oxide, titanium oxide, tin oxide, indium oxide alloy, silicon nitride, aluminum nitride, and titanium nitride. In addition, as the inorganic layer, a metal film, for example, an aluminum film, a silver film, a tin film, a chromium film, a nickel film, or a titanium film may be provided.

Among these materials, it is particularly preferable that the inorganic layer having barrier properties is an inorganic layer including at least one compound selected from silicon nitride, silicon oxynitride, silicon oxide, or aluminum oxide. Since the inorganic layer formed of these materials has satisfactory adhesiveness with the organic layer, even in a case where the inorganic layer has pinholes, the organic layer can effectively fill the pinholes and fractures can be suppressed. Further, a very satisfactory inorganic layer film can be formed even in a case where the inorganic layers are laminated, and barrier properties can be further improved.

The method for forming the inorganic layer is not particularly limited and for example, various film formation methods capable of accumulating film forming materials on a surface to be vapor-deposited by evaporating or scattering the film forming materials can be used.

Examples of the method for forming the inorganic layer include a vacuum vapor deposition method of heating and vapor-depositing an inorganic material such as inorganic oxide, inorganic nitride, inorganic oxynitride, or metal; an oxidation reaction vapor deposition method of using an inorganic material as a raw material, oxidizing the inorganic material by introducing an oxygen gas, and vapor-depositing the material; a sputtering method of using an inorganic material as a target raw material, introducing an argon gas and an oxygen gas, and vapor-depositing the material by sputtering; a physical vapor deposition method such as an ion plating method of heating an inorganic material by a plasma beam generated by a plasma gun and vapor-depositing the material; and a plasma chemical vapor deposition method using an organic silicon compound as a raw material in a case where a vapor deposition film of silicon oxide or silicon nitride is formed. Vapor deposition may be performed on the surface of a base material such as a support, a base material film, a wavelength conversion layer, or an organic layer.

A silicon oxide film is preferably formed by a low temperature plasma chemical vapor deposition method using an organic silicon compound as a raw material. Specific examples of the organic silicon compound include 1,1,3,3-tetramethyldisiloxane, hexamethyldisiloxane, vinyltrimethylsilane, hexamethyldisilane, methylsilane, dimethylsilane, trimethylsilane, diethylsilane, propylsilane, phenylsilane, vinyltriethoxysilane, tetramethoxysilane, phenyltrimethoxysilane, methyltriethoxysilane, and octamethylcyclotetrasiloxane. In addition, among the organic silicon compounds, tetramethoxysilane (TMOS) and hexamethyldisiloxane (HMDSO) are preferably used. This is because these compounds are excellent in handleability and vapor deposition film properties.

The thickness of the inorganic layer may be 1 nm to 500 nm and is preferably 5 nm to 300 nm, and particularly preferably 10 nm to 150 nm. By setting the thickness of the adjacent inorganic layer to be in the above range, satisfactory barrier properties can be realized and reflection in the inorganic layer can be suppressed. Thus, a laminated film having higher light transmittance can be provided.

At least one inorganic layer adjacent to the optical functional layer is preferably included in the functional film FF. The inorganic layers are preferably in direct contact with both surfaces of the optical functional layer.

—Organic Layer—

The organic layer is a layer having an organic material as a main component and is preferably a layer including 50% by mass or more, further 80% by mass or more, and particularly 90% by mass or more of an organic material.

Regarding the organic layer, paragraphs 0020 to 0042 of JP2007-290369A and paragraphs 0074 to 0105 of JP2005-096108A can be referred to. The organic layer preferably includes a cardo polymer in a range in which the above adhesiveness condition is satisfied. Thus, adhesiveness between the organic layer and an adjacent layer, in particular, adhesiveness between the organic layer and the inorganic layer is improved, and more satisfactory barrier properties can be realized. Regarding the details of the cardo polymer, paragraphs “0085” to “0095” of JP2005-096108A can be referred to. The thickness of the organic layer is preferably in a range of 0.05 μm to 10 μm and more preferably in a range of 0.5 to 10 μm. In a case where the organic layer is formed using a wet coating method, the thickness of the organic layer is preferably in a range of 0.5 to 10 μm and more preferably in a range of 1 μm to 5 μm. In a case where the organic layer is formed using a dry coating method, the thickness of the organic layer is preferably in a range of 0.05 μm to 5 μm and more preferably in a range of 0.05 μm to 1 μm. By adjusting the thickness of the organic layer, which is formed using a wet coating method or a dry coating method, adhesiveness with the inorganic layer can be further improved.

With respect to other details of the inorganic layer and the organic layer, the descriptions of JP2007-290369A, JP2005-096108A, and US2012/0113672A1 can be referred to.

### EXAMPLES

Hereinafter, the present invention will be described in detail with reference to examples. However, the present invention is not limited to these examples and materials, amounts to be used, proportions, treatment contents, treatment procedures and the like shown in examples below can be appropriately changed without departing from the gist of the present invention.

### Example 1

(Preparation of Functional Film)

An optical functional layer forming coating solution including a quantum dot (hereinafter, referred to as a coating solution) was used as a coating solution forming an optical functional layer and gas barrier films were used as a flexible support W and a film F. In addition, the inert gas to be supplied to the reduced pressure chamber 15 was supplied from the slit 54 provided in the die coater 36.

<<Preparation of Flexible Support>>

<Support>

A polyethylene terephthalate film (PET film, trade name: COSMOSHINE A4300, manufactured by Toyobo Co., Ltd., thickness: 50 μm, width: 1000 mm, length: 100 m) of which only one surface was undercoated with an easily adhesive layer was used.

<Formation of Organic Layer>

An organic layer was formed on the support. First, an organic layer forming coating solution was prepared. For the organic layer forming coating solution, trimethylolpropane triacrylate (TMPTA, manufactured by DAICEL-ALLNEX LTD.) and a photopolymerization initiator (ESACUREKTO46, manufactured by Lamberti S.p.A.) were prepared and weighed such that a weight ratio of TMPTA:photopolymerization initiator was 95:5, and these materials were dissolved in methyl ethyl ketone to obtain a coating solution having a concentration of solid contents of 15%.

The organic layer forming coating solution was applied to a smooth surface of the PET film, as a support, opposite to the easily adhesive surface using a roll-to-roll method with a die coater. After coating, the PET film was allowed to pass through a dry zone at 50° C. for 3 minutes and then irradiated with ultraviolet rays (cumulative irradiation dose: about 600 mJ/cm²) to be cured by UV curing. In addition, a protective film of a polyethylene film (PE film, trade name: PAC2-30-T, manufactured by Sun A. Kaken Co., Ltd.) was bonded to the flexible support W by a pass roll immediately after UV curing, was transported, and then was rolled. The thickness of the organic layer formed on the support was 1 μm.

<Formation of Inorganic Layer>

Next, using a roll-to-roll chemical vapor deposition (CVD) apparatus, an inorganic layer (silicon nitride (SiN) layer) was formed on the surface of the organic layer formed on the support. The support on which the organic layer was formed was fed by a feeding machine and was allowed to pass through a final film surface touch roll before an inorganic layer was formed, and the protective film was peeled off. Then, an inorganic layer was formed on the exposed organic layer. For the formation of the inorganic layer, as raw material gases, silane gas (flow rate: 160 sccm), ammonia gas (flow rate: 370 sccm), hydrogen gas (flow rate: 590 sccm), and nitrogen gas (flow rate: 240 sccm) were used. As a power supply, a high frequency power supply having a frequency of 13.56 MHz was used to form the SiN layer. The film forming pressure was 40 Pa, and the achieved thickness was 50 nm.

In this manner, the inorganic layer was formed on the organic layer and then the protect PE film was bonded thereto in the film surface touch roll portion after the inorganic layer was formed. Then, the inorganic layer was transported without contact with the pass roll and then rolled. In this manner, a flexible support W for applying the coating solution was prepared.

(Coating Solution Preparation Step)

<Composition of Coating Solution>

A quantum dot dispersion liquid having the following composition was prepared and used as a coating solution.
Dispersion liquid of quantum dot 1 in toluene (emission maximum: 520 nm) 10 parts by mass
Dispersion liquid of quantum dot 2 in toluene (emission maximum: 630 nm) 1 part by mass
Lauryl methacrylate 2.4 parts by mass
Trimethylolpropane triacrylate 0.54 parts by mass
Photopolymerization initiator 0.009 parts by mass

(IRGACURE 819 (registered trademark) (manufactured by Chiba Speciality Chemicals))

For the quantum dots 1 and 2, the following nanocrystals having a core-shell structure (InP/ZnS) were used.
Quantum dot 1: INP530-10 (manufactured by y NN-Labs, LLC)
Quantum dot 2: INP620-10 (manufactured by y NN-Labs, LLC)

(Solvent Volatilization and Dissolved Oxygen Reduction Step)

The coating solution obtained in the coating solution preparation step was supplied into the tank 26 and was stirred with the stirrer 32 while supplying nitrogen gas into the tank 26, and dissolved oxygen in the coating solution was substitute by nitrogen gas such that the dissolved oxygen concentration in the coating solution was set to 1000 ppm or less. Then, the pressure in the tank 26 was reduced by the pressure reducing pipe 33 to volatilize toluene in the coating solution. The concentration of toluene in the coating solution was 11000 ppm. Then, the coating solution was supplied to the manifold 48 of the die coater 36. The viscosity of the coating solution after the solvent was volatilized was 50 mPa·s.

(Coating Step)

The coating solution was discharged from the slit 50 of the die coater 36 and continuously applied to the inorganic layer of the flexible support W (from which the protective polyethylene (PE) film was peeled off) which was transported in a state in which the support was wound around the backup roller 44. Thus, a coated film CF was formed. A gap between the land 37 of the die coater 36 and the backup roller 44 was 200 μm and a die coater having a die block width of 1000 mm was used for coating.

(Inert Gas Supply Step)

The nitrogen gas was discharged from the slit 54 provided in the die coater 36 into the reduced pressure chamber 15 and to the flexible support W in a supply amount of 1000 L/min/m. In addition, air in the reduced pressure chamber 15 was exhausted by the blower 58. The exhaust amount from the reduced pressure chamber 15 was set to 1030 L/min/m. The pressure reduction degree in the reduced pressure chamber 15 was 2 Pa. Further, adjustment of the oxygen concentration in the reduced pressure chamber was performed by setting a target value of the oxygen concentration in the reduced pressure chamber 15 to 1000 ppm, and mixing the inert gas to be supplied and air to be sucked from the gap between the reduced pressure chamber 15 and the flexible support W (not adjusted).

(Lamination Step)

The coated surface of the coated film CF and the film F were laminated on the backup roller 44. That is, the film F which was transported in a state in which the film was wound around the lamination roller 74 was laminated on the coated surface of the coated film CF which was transported in a state in which the film was wound around the backup roller 44.

(Curing Step)

The curing device 20 arranged on the arranged on the backup roller 44 was used. That is, while purging with nitrogen, the laminated film LF was irradiated with ultraviolet rays using an air cooling metal halide lamp (manufactured by EYE GRAPHICS CO., LTD.) of 160 W/cm² as the actinic ray irradiation device 76 and the coating C was cured to produce a functional film FF.

### Reference Example

A sample to which the coating solution was applied without supplying nitrogen gas to the reduced pressure chamber and performing exhaustion from the reduced pressure chamber was produced as a reference example.

### Comparative Example 1

A functional film was produced in the same manner as in Example 1 except that the supply amount of nitrogen gas to be supplied was set to 1000 L/min/m, the exhaust amount from the reduced pressure chamber 15 was set to 1000 L/minim, and the pressure reduction degree in the reduced pressure chamber was set to 0 Pa.

### Example 2

A functional film was produced in the same manner as in Example 1 except that the pressure in the tank 26 was reduced by the pressure reducing pipe 33 and toluene in the coating solution was volatilized until the concentration of toluene reached 9000 ppm.

### Example 3

A functional film was produced in the same manner as in Example 1 except that the supply amount of nitrogen gas was set to 1000 L/minim, the exhaust amount from the reduced pressure chamber 15 was set to 1070 L/min/m, and the pressure reduction degree in the reduced pressure chamber was set to 12 Pa.

### Example 4

A functional film was produced in the same manner as in Example 3 except that as nitrogen gas to be supplied, nitrogen gas of which the oxygen concentration was adjusted to 100 ppm before the nitrogen gas was discharged from the die coater 36 was used (adjusted).

[Evaluation Method]

(Oxygen Concentration Variation Width)

An oxygen concentration distribution in the reduced pressure chamber was measured and values (percent) were obtained by dividing a difference between the upper limit of the oxygen concentration in the reduced pressure chamber and the average value of the oxygen concentration, and a difference between the lower limit and the average value by the average value of the oxygen concentration. Evaluation was performed based on these values.

A . . . within ±5%

B . . . within ±10%

C . . . more than 10%

(Performance of Functional Film)

The brightness immediately after the samples were prepared (cd/cm²), and the brightness after the samples were put in a dry oven at 85° C. for 100 hours were measured and a value was obtained by dividing the brightness immediately after the samples were preparation by the brightness after the samples were put in a dry oven for 100 hours to perform evaluation based on the value. In the following evaluation, grades A and B are in the range of the present invention.

A . . . 0.95 to 1.0

B . . . 0.85 to less than 0.95

C . . . less than 0.85

The results are shown in Table 1.

TABLE 1

| | Conditions of upstream side of die coater | | | | | | | |
|---|---|---|---|---|---|---|---|---|
| | Target | | | | Pressure | | | |
| | oxygen | | | Exhaust | reduction | Concentration | | |
| | concentration | | | amount of | degree of | of organic | Evaluation | |
| | in reduced | | Supply | reduced | reduced | solvent | Oxygen | Performance |
| | pressure | Oxygen | amount | pressure | pressure | in coating | concentration | of |
| | chamber | concentration | of N₂ | chamber | chamber | solution | variation | functional |
| | [ppm] | of inert gas | [L/min/m] | [L/min/m] | [Pa] | [ppm] | width | film |
| Reference | — | — | — | — | 0 | 11000 | — | C |
| Example | | | | | | | | |
| Comparative | 1000 | Not adjusted | 1000 | 1000 | 0 | 11000 | C | B~C |
| Example 1 | | | | | | | | |
| Example 1 | 1000 | Not adjusted | 1000 | 1030 | 2 | 11000 | B | B |
| Example 2 | 1000 | Not adjusted | 1000 | 1030 | 2 | 9000 | A | A |
| Example 3 | 1000 | Not adjusted | 1000 | 1070 | 12 | 11000 | A | A |
| Example 4 | 100 | Adjusted | 1000 | 1070 | 12 | 11000 | A | A |

[Evaluation Results]

In Examples 1 to 4 in which the pressure in the reduced pressure chamber 15 was reduced, the oxygen concentration in the reduced pressure chamber could be stabilized and the performance of the functional films produced was satisfactory. In Comparative Example 1 in which the pressure in the reduced pressure chamber 15 was not reduced, the oxygen concentration distribution in the reduced pressure chamber 15 was not stabilized and there was a difference in performance of the functional film produced. In addition, in Reference Example in which nitrogen gas was not supplied, the performance of the functional film produced was deteriorated. By reducing the concentration of the organic solvent in the coating solution (Example 2), increasing the pressure reduction degree in the reduced pressure chamber 15 (Example 3), or supplying nitrogen gas of which the oxygen concentration was adjusted (Example 4), the oxygen concentration in the reduced pressure chamber 15 could be further stabilized and a functional film without a difference in performance could be produced.

### EXPLANATION OF REFERENCES

10: apparatus for producing functional film
12: dissolved oxygen reducing device
14: coating device
15 reduced pressure chamber
15A: side plate
15B: back plate
15C: bottom plate
15D: opening
15E: opening portion
16: inert gas supply device
18: lamination device
20: curing device
22: nitrogen gas substituting means
24: coating solution supply means
26: tank
28: coating solution pipe
30: nitrogen gas pipe
32: stirrer
34: air vent pipe
36: die coater
36A: body portion
36B: distal end lip portion
36C: upstream side lip land
36D: downstream side lip land
36E: upstream side inclined surface
37: land
38: liquid feeding pipe
40: liquid feeding pump
42: nitrogen gas blowing pipe
44: backup roller
46A, 46B, 46C: die block
48, 52: manifold
50, 54: slit
50A: slit discharging port
56: pipe
58: blower
62: nitrogen cylinder
64: air cylinder
66: common supply pipe
68: nitrogen gas supply pipe
70: air supply pipe
72: measurement means
74: lamination roller
76: actinic ray irradiation device
78: peeling roller
215: reduced pressure chamber
215A: side plate
215B: back plate
215C: bottom plate
215E: inert gas supply port
236: die coater
246A, 246B: die block
248: manifold
250: slit
250A: discharging port
W: flexible support
CF: coated film
F: film to be laminated
LF: laminated film
FF: functional film
C: coating

What is claimed is:

1. A method for producing a functional film comprising
a coating step of supplying a coating solution having a dissolved oxygen concentration of 1000 ppm or less to a die coater having a backup roller and applying the coating solution to a flexible support which is transported in a state in which the support is wound around the backup roller by the die coater,
wherein a reduced pressure chamber which covers a surface of the flexible support is provided on an upstream side of the die coater in a transport direction of the flexible support, and
an inert gas is supplied to the reduced pressure chamber and an exhaust amount from the reduced pressure chamber is larger than a supply amount of the inert gas to the reduced pressure chamber.

2. The method for producing a functional film according to claim 1,
wherein a concentration of an organic solvent in the coating solution is 10000 ppm or less.

3. The method for producing a functional film according to claim 1,
wherein a pressure reduction degree in the reduced pressure chamber is 10 Pa or more.

4. The method for producing a functional film according to claim 1,
wherein an oxygen concentration of the inert gas is adjusted to less than 5000 ppm.

5. The method for producing a functional film according to claim 1,
wherein a supply amount of the inert gas is 100 L/min/m or more and 10000 L/min/m or less.

6. An apparatus for producing a functional film comprising:
a coating device having a backup roller and a die coater for applying a coating solution having a dissolved oxygen concentration of 1000 ppm or less to a flexible support which is transported in a state in which the support is wound around the backup roller;
a reduced pressure chamber which covers a surface of the flexible support and is provided on an upstream side in a transport direction of the flexible support;
an inert gas supply device for supplying an inert gas into the reduced pressure chamber; and
an exhaust device for exhausting a gas in the reduced pressure chamber,
wherein an exhaust amount of the exhaust device is larger than a supply amount of the inert gas supply device.

7. The apparatus for producing a functional film according to claim 6,
wherein a concentration of an organic solvent in the coating solution is 10000 ppm or less.

8. The apparatus for producing a functional film according to claim 6,
wherein the inert gas supply device is a die block having a slit which is arranged on an upstream side of the die coater in the transport direction of the flexible support and is provided for supplying the inert gas.

9. The apparatus for producing a functional film according to claim 6,
wherein a pressure reduction degree in the reduced pressure chamber is 10 Pa or more.

10. The apparatus for producing a functional film according to claim 6,
wherein an oxygen concentration of the inert gas is adjusted to less than 5000 ppm.

11. The apparatus for producing a functional film according to claim 6,
wherein a supply amount of the inert gas is 100 L/min/m or more and 10000 L/min/m or less.
